(19) United States
(12) Patent Application Publication
(10) Pub. No.: US 2023/0234252 A1
(43) Pub. Date: Jul. 27, 2023

(54) Shaving Blade Device

(71) Applicant: Jeremy Hernandez, Houston, TX (US)

(72) Inventor: Jeremy Hernandez, Houston, TX (US)

(21) Appl. No.: 17/584,565

(22) Filed: Jan. 26, 2022

(51) Int. Cl. B26B 21/56; B26B 21/22; B26B 21/52; B26B 21/28

(52) U.S. Cl. CPC B26B 21/56; B26B 21/22; B26B 21/523; B26B 21/28

(57) ABSTRACT

A shaving blade device for precision shaving and trimming includes a razor blade having a mounting edge and a cutting edge. The mounting edge is selectively engageable to a straight razor assembly so that the razor blade is removably engaged to the straight razor assembly. A cutout, which extends into the cutting edge and a first end of the razor blade, defines a length of the cutting edge. The cutting edge is used to shave hair from skin and to trim hair and is particularly useful in precision shaving and trimming in hard to reach areas.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shaving devices and more particularly pertains to a new shaving device for precision shaving and trimming. The present invention discloses a shaving device comprising a razor blade having a width less than the width of a standard razor blade. The razor blade is selectively engageable to a straight razor handle assembly for use in precision trimming and shaping.

### (2) Description of Related Art Including Information Disclosed Under 37 CFR 1.97 and 1.98

The prior art relates to shaving devices, and more particularly to razor blades. The prior art comprises standard commercially available shaving devices either of a disposable nature or having replaceable razor blades. These prior art shaving devices have razor blades of a standard width, typically 4.00 to 4.50 cm. Prior art shaving devices also comprises shaving devices with razor blades that are smaller than normal, and shaving devices with multiple, differently sized, razor blades. What is lacking in the prior art is a razor blade having a width less than the width of a standard razor blade, wherein the razor blade is selectively engageable to a straight razor handle assembly for use in precision trimming and shaping.

### BRIEF SUMMARY OF THE INVENTION

An embodiment of the disclosure meets the needs presented above by generally comprising a razor blade having a mounting edge and a cutting edge. The mounting edge is configured to selectively engage a straight razor assembly so that the razor blade is removably engaged to the straight razor assembly. A cutout, which extends into the cutting edge and a first end of the razor blade, defines a length of the cutting edge. The cutting edge is configured to shave hair from skin and to trim hair and is particularly useful in precision shaving and trimming in hard to reach areas.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a shaving blade device according to an embodiment of the disclosure.

FIG. 2 is a side view of an embodiment of the disclosure.

FIG. 3 is a cross-sectional view of an embodiment of the disclosure.

FIG. 4 is an in-use view of an embodiment of the disclosure.

FIG. 5 is a front view of a typical prior art device.

### DETAILED DESCRIPTION OF THE INVENTION

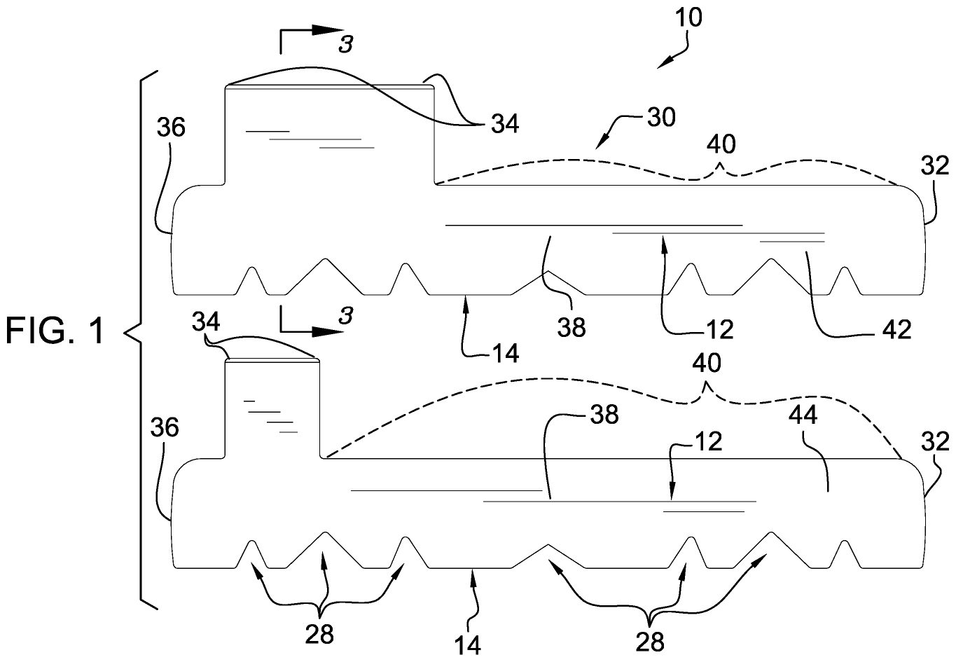

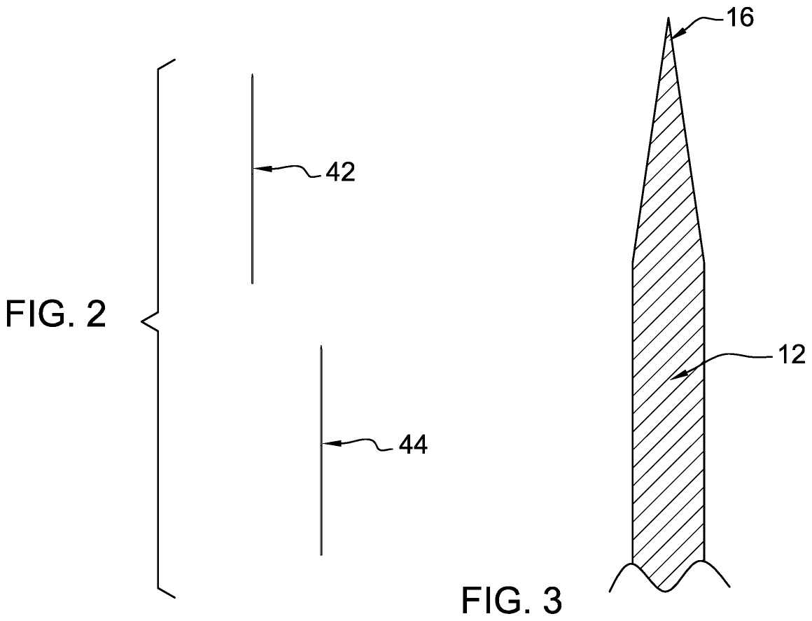

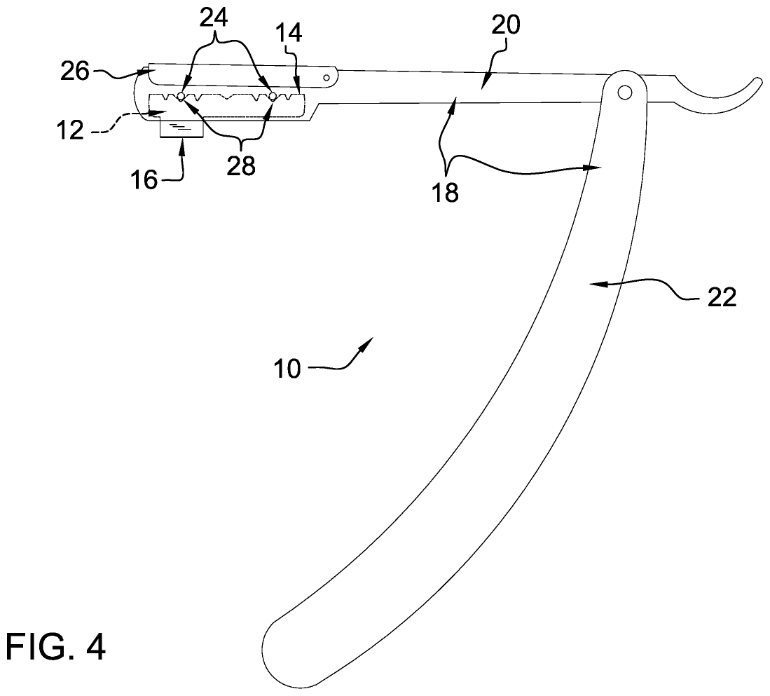

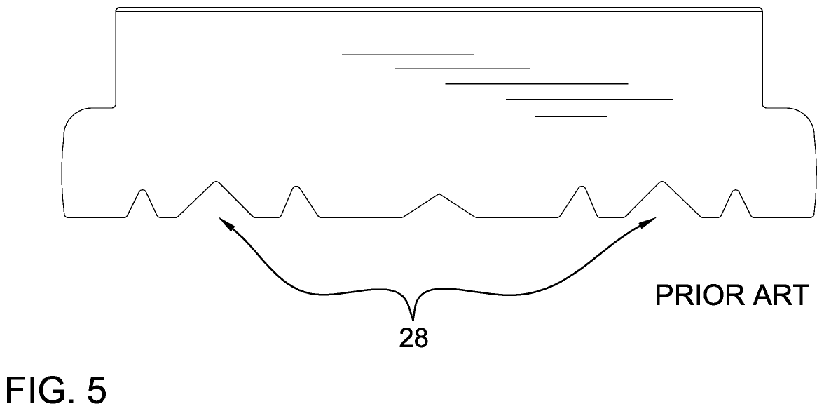

With reference now to the drawings, and in particular to FIGS. 1 through 5 thereof, a new shaving device embodying the principles and concepts of an embodiment of the disclosure and generally designated by the reference numeral 10 will be described.

As best illustrated in FIGS. 1 through 5, the shaving blade device 10 generally comprises shaving blade device 10 a razor blade 12 having a mounting edge 14 and a cutting edge 16. The mounting edge 14 is configured to selectively engage a straight razor assembly 18 so that the razor blade 12 is removably engaged to the straight razor assembly 18.

The straight razor assembly 18 comprises an arm 20, which is hingedly engaged to a handle 22. A pair of positioning pins 24 is engaged to the arm 20 distal from the handle 22. A clip 26 is engaged to the arm 20 and is selectively engageable to the razor blade 12. A plurality of voids 28 extends into the mounting edge 14. Respective voids 28 are configured for insertion of the positioning pins 24. The clip 26 is positioned to selectively engage the razor blade 12 to removably engage the razor blade 12 to the arm 20.

A cutout 30, which extends into the cutting edge 16 and a first end 32 of the razor blade 12, defines a length 34 of the cutting edge 16. As the mounting edge 14 is symmetrical, the razor blade 12 can be mounted to the arm 20 with the cutting edge 16 positioned either distally from or proximate to the handle 22. The present invention also anticipates the cutout 30 comprising a pair of cutouts 30 (not shown) extending into the cutting edge 16 from the first end 32 and a second end 36 of the razor blade 12. The cutting edge 16 thus would be positioned proximate to a center 38 of the razor blade 12. The cutting edge 16 is configured to shave hair from skin and to trim hair and is particularly useful in precision shaving and trimming in hard to reach areas. One example of use would be in shaving lines in hair of a scalp to create a design.

The razor blade 12 may be one of a plurality of razor blades 12, with each razor blade 12 having a mounting edge 14 and a cutting edge 16. The mounting edge 14 is configured to selectively engage a straight razor assembly 18 so that the razor blade 12 is removably engaged to the straight razor assembly 18. Each razor blade 12 has a cutout 30 extending into the cutting edge 16 and the first end 32 of the razor blade 12, thereby defining the length 34 of the cutting edge 16. The cutting edge 16 is configured to shave hair from skin and to trim hair. Each cutout 30 has a respective width 40 so that the plurality of razor blades 12 comprises razor blades 12 with cutting edges 16 having a variety of lengths 34.

The plurality of razor blades 12 may comprise a first blade 42 and a second blade 44. The cutting edge 16 of the first blade 42 has a length 34 of approximately 1.27 cm. The cutting edge 16 of the second blade 44 has a length 34 of approximately 0.64 cm. The present invention also anticipates the plurality of razor blades 12 comprising razor blades 12 with cutting edges 16 having different lengths 34, such as, but not limited to, 0.45 cm, 0.75 cm, 150 cm, and the like.

In use, a respective razor blade 12 having a cutting edge 16 of a desired length 34 is engaged to the straight razor assembly 18 using the positioning pins 24 and the clip 26. The user then can use the razor blade 12 to shave hair from skin and to trim hair.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A shaving blade device comprising:
a razor blade having a mounting edge and a cutting edge, wherein the mounting edge is configured for selectively engaging a straight razor assembly, such that the razor blade is removably engageable with the straight razor assembly; and
a cutout extending into the cutting edge and a first end of the razor blade, the cutout defining a length of the cutting edge, wherein the cutting edge is configured for shaving of hair from skin and for trimming of hair; and
a plurality of voids extending into the mounting edge, all of the voids of the plurality of voids being triangular wherein respective voids of the plurality of voids are configured for insertion of positioning pins engaged to an arm of the straight razor assembly, wherein the razor blade is configured for a clip of the straight razor assembly to engage the razor blade for removably engaging the razor blade to the arm.

2. (canceled)

3. The shaving blade device of claim 1, further including:
the razor blade being one of a plurality of razor blades, each razor blade having a respective mounting edge and a respective cutting edge, wherein the mounting edge of each razor blade is configured for selectively engaging the straight razor assembly, such that each razor blade of the plurality of razor blades is removably engaged to the straight razor assembly; and
each of the razor blades having a respective cutout extending into the cutting edge and the first end of the razor blade, the respective cutout defining the length of the cutting edge of each razor blade, wherein the cutting edge of each razor blade is configured for shaving of hair from skin and for trimming of hair, the cutout of each razor blade having a respective width, such that the plurality of razor blades comprises a variety of lengths for the respective cutting edges of the plurality of razor blades.

4. The shaving blade device of claim 3, further wherein the plurality of razor blades comprises:
a first blade, the length of the cutting edge of the first blade being 1.27 cm; and
a second blade, the length of the cutting edge of the second blade being 0.64 cm.

5. A shaving blade system comprising:
a straight razor assembly, the straight razor assembly comprising:
an arm hingedly engaged to a handle,
a pair of positioning pins engaged to the arm distal from the handle, and
a clip engaged to the arm and to the razor blade;
a razor blade having a mounting edge and a cutting edge, the mounting edge being selectively engaged to the straight razor assembly, such that the razor blade is removably engaged to the straight razor assembly; and
a cutout extending into the cutting edge and a first end of the razor blade, the cutout defining a length of the cutting edge, wherein the cutting edge is configured for shaving of hair from skin and for trimming of hair; and
a plurality of voids extending into the mounting edge, all of the voids of the plurality of voids being triangular wherein respective voids of the plurality of voids are configured for insertion of positioning pins engaged to an arm of the straight razor assembly, wherein the razor blade is configured for a clip of the straight razor assembly to engage the razor blade for removably engaging the razor blade to the arm.

6. (canceled)

7. The shaving blade system of claim 5, further including:
the razor blade being one of a plurality of razor blades, each razor blade having a respective mounting edge and a respective cutting edge, the mounting edge of each razor blade being selectively engaged to the straight razor assembly, such that each razor blade of the plurality of razor blades is removably engageable to the straight razor assembly; and
each of the razor blades having a respective cutout extending into the cutting edge and the first end of the razor blade, the respective cutout defining the length of the cutting edge of each razor blade, wherein the cutting edge is configured for shaving of hair from skin and for trimming of hair, the cutout of each razor blade having a respective width, such that the plurality of razor blades comprises a variety of lengths for the respective cutting edges of the plurality of razor blades.

8. The shaving blade system of claim 7, further wherein the plurality of razor blades comprises:
a first blade, the length of the cutting edge of the first blade being 1.27 cm; and
a second blade, the length of the cutting edge of the second blade being 0.64 cm.

9. A shaving blade device comprising:
a razor blade having a mounting edge and a cutting edge, wherein the mounting edge is configured for selectively engaging a straight razor assembly, such that the razor blade is removably engaged to the straight razor assembly;
a plurality of voids extending into the mounting edge, all of the voids of the plurality of voids being triangular wherein respective voids are configured for insertion of positioning pins engaged to an arm of the straight razor assembly, wherein the razor blade is configured for a clip of the straight razor assembly to engage the razor blade to the arm;
a cutout extending into the cutting edge and a first end of the razor blade defining a length of the cutting edge, wherein the cutting edge is configured for shaving of hair from skin and for trimming of hair;
the razor blade being one of a plurality of razor blades, each razor blade having a respective mounting edge and a respective cutting edge, wherein the mounting edge of each razor blade is configured for selectively engaging Rail the straight razor assembly, such that each razor blade of the plurality of razor blades is removably engaged to the straight razor assembly; and
each of the razor blades having a respective cutout extending into the cutting edge and the first end of the razor blade, the respective cutout defining the length of the cutting edge of each razor blade, wherein the cutting edge of each razor blade is configured for shaving of hair from skin and for trimming of hair, the cutout of each razor blade having a respective width, such that the plurality of razor blades comprises a variety of lengths for the respective cutting edges, the plurality of razor blades comprising:
a first blade, the length of the cutting edge of the first blade being 1.27 cm, and
a second blade, the length of the cutting edge of the second blade being 0.64 cm.
